(19) United States
(12) Patent Application Publication
(10) Pub. No.: US 2010/0051181 A1
(43) Pub. Date: Mar. 4, 2010

(54) Manufacturing Equipment and Manufacturing Method of Membrane Electrode Assembly

(75) Inventor: Hideki Mori, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/508,472

(22) Filed: Jul. 23, 2009

(30) Foreign Application Priority Data
Aug. 28, 2008 (JP) 2008-219399

(51) Int. Cl. H01M 4/04; B32B 37/14

(52) U.S. Cl. 156/184; 156/390

(57) ABSTRACT

The present invention provides a manufacturing method and manufacturing equipment which makes it possible to manufacture a fuel cell MEA (membrane electrode assembly) continuously and stably with a high level of precision. The present invention provides a manufacturing method of a fuel cell MEA which includes transferring three carrier films in belt shapes, coating an electrolyte membrane in predetermined regions on one of the carrier films, coating electrode catalyst layers intermittently in predetermined regions on the other two carrier films, drying the electrolyte and the electrode catalyst layers on the carrier films, laminating the electrolyte membrane onto an electrode catalyst layer on one of the carrier films with a pressure and peeling off and removing the carrier film of the electrolyte membrane, laminating the other electrode catalyst layer onto the electrolyte membrane laminated on the electrode catalyst layer with heat and a pressure, and peeling off the carrier films from the resultant laminated product of the electrolyte membrane and the electrode catalyst layers.

### CROSS REFERENCE TO RELATED APPLICATION

This application is based on and claims the benefit of priority from the Japanese Patent Application number 2008-219399, filed on Aug. 28, 2008, the entire contents of which are incorporated herein by reference.

### BACKGROUND OF THE INVENTION

1. Field of the Invention

The present invention relates to a manufacturing method and manufacturing equipment which make it possible to fabricate a membrane electrode assembly (MEA) of a fuel cell having electrode catalyst layers on both (rear and front) surfaces of an electrolyte membrane with a high precision continuously and stably.

2. Description of the Related Art

A component which has electrode catalyst layers on both rear and front surfaces of a polymer electrolyte membrane and which is called a membrane electrode assembly (MEA) is used in a polymer electrolyte fuel cell. A heat pressing technique and a laminating technique are available as a forming method of the MEA.

The heat pressing technique is a technique in which electrode layers having catalysts on both rear and front surfaces of a polymer electrolyte are arranged overlapping each other, heated and pressed using a heat pressing machine. The heat pressing technique has a relatively small number of process parameters such as heating temperature, pressing pressure, period of heating and pressing. In addition, the heat pressing technique costs low since only a simple type of equipment is required. The heat pressing technique, however, has low productivity because it adopts (not a continuous processing but) a batch processing system.

On the other band, the laminating technique, in which heat and pressure are applied by a roll, is generally used in the case where the polymer electrolyte membrane is a web substrate. Although major process parameters are heating temperature, pressing pressure and feeding rate of the web substrate, it is necessary to control a tension of the web substrate and speeds of a plurality of rolls. Thus, a rather complicated and expensive instrument is required. However the laminating technique is superior in productivity because a continuous processing can be applied.

In addition, while the heat pressing technique requires precise in-plane uniformity in pressure and temperature, the laminating technique in which heat pressing rolls are employed requires only in-line uniformity in pressure and temperature on a contacting line of the pair of rolls so that it is easier to make uniformity in pressure and temperature.

In some MEA, it is preferable that not all the surface of the polymer electrolyte membrane independent of rear and front is covered with the electrode catalyst layers but some area of the polymer electrolyte membrane is still uncovered with the electrode catalyst layers while the other is covered. It is because such an MEA is more likely to form a sealing structure which makes it impossible for fuel gas or oxygen gas to leak and it is easier to prevent a shortage between both surfaces of the polymer electrolyte membrane.

For example, the patent document 1 discloses a method in which an anode catalyst layer or a cathode catalyst layer is laminated on each of both surfaces of an electrolyte membrane by a heat pressing roll after a uniform layer is coated on its carrier film, and the carrier film is finally removed.

<Patent document 1>JP-A-2003-257438

### SUMMARY OF THE INVENTION

In the method described in the patent document 1, the anode catalyst layer or the cathode catalyst layer is preliminarily formed on the carrier film continuously while convexities and concavities are formed on the heat pressing roll. The carrier film is heat-pressed around the convexities so that the anode catalyst layer or the cathode catalyst layer is laminating and transferred to the electrolyte membrane, whereas around the concavities, the anode catalyst layer or the cathode catalyst layer is not laminated and transferred to the electrolyte membrane since the film is not heat-pressed. The content of the patent document 1 is a technique for fabricating an electrolyte membrane having both regions on which the anode catalyst layer or the cathode catalyst layer is formed and on which the anode catalyst layer or the cathode catalyst layer is not formed by arranging heat-pressing convexities and non-heat-pressing concavities.

In the case of the technique described in the patent document 1, however, the concavities and convexities are formed on a single heat pressing roll, which has a problem that a pressure distribution of the anode catalyst layer or the cathode catalyst layer formed on both surfaces of the electrolyte membrane is inclined to be uneven. In addition, since shearing forces are applied to the electrolyte membrane around convexities' edges of the heat pressing roll, the fuel gas and the oxygen gas may leak.

In addition, the presence of convexities and concavities on the heat pressing roll means that the roll has an unfixed diameter. Thus, a tension applied to the electrolyte membrane and the carrier film changes every moment during heat pressing. As a result, a feed rate, a transfer rate or a winding rate etc. does not become constant, which prevents the anode catalyst layer or the cathode catalyst layer from being coated evenly on a respective carrier film and leads to an uneven coating thickness.

Moreover, as an area of the anode catalyst layer and cathode catalyst layer becomes large, the carrier film applied with tension may deform to contact with a concavities' bottom on the heat pressing roll. In other words, undesirable parts may be heated and pressed to form an anode catalyst layer and a cathode catalyst layer in undesirable regions by laminate. Since a sealing material is supposed to be arranged in these regions in a latter process, such catalyst layers formed in these regions on the electrolyte membrane cause sealing defects and thus the production efficiency decreases.

In addition, some parts of the anode catalyst layer and cathode catalyst layer coated on the carrier film are left without being transferred onto the electrolyte membrane. The parts of the catalyst layer left on the carrier film may be reprocessed by another process or disposed, which is rather inferior from the viewpoint of material efficiency.

The present invention relates to a manufacturing method and manufacturing equipment of an MEA having a predetermined pattern of a laminated electrode catalyst layer on both sides of the electrolyte membrane. Specifically, the present invention provides a manufacturing method and manufacturing equipment of an MEA which has stable producing quality and a high level of productivity by making it possible to stably form an electrode catalyst layer having a predetermined area, shape and thickness, and to stably control process conditions of laminating the electrode catalyst layer onto both surfaces of an electrolyte membrane such as temperature, pressure and transfer rate of the carrier film.

In order to solve the problems mentioned above, a first aspect of the present invention is manufacturing equipment of a fuel cell MEA which includes a first transfer means for feeding, transferring, and winding a first carrier film in a belt shape; a first coating means for coating an electrolyte material in predetermined regions on the first carrier film; a first drying means for drying the electrolyte material coated on the first carrier film to transform into an electrolyte membrane; a second transfer means for feeding, transferring, and winding a second carrier film in a belt shape; a second coating means for intermittently coating an electrode catalyst layer material in predetermined regions on the second carrier film; a second drying means for drying the electrode catalyst layer material coated intermittently on the second carrier film to transform into an electrode catalyst layer; a third transfer means for feeding, transferring, and winding a third carrier film in a belt shape; a third coating means for intermittently coating an electrode catalyst layer material in predetermined regions on the third carrier film; a third drying means for drying the electrode catalyst layer material coated intermittently on the third carrier film to transform into an electrode catalyst layer; a press-laminating means for laminating the electrolyte membrane formed on the first carrier film onto the electrode catalyst layer on the second carrier film with a pressure followed by peeling off and removing the first carrier film; and a heat-laminating means for laminating the electrode catalyst layer on the third carrier film onto the electrolyte membrane with heat and a pressure.

In addition, a second aspect of the present invention is the manufacturing equipment according to the first aspect of the present invention which further includes a synchronizing means for synchronizing intermittently coatings on the second carrier film and on the third carrier film when the electrode catalyst materials are intermittently coated; and a tension control means for controlling a transfer rate and a tension of the first to third carrier films, wherein the second and third coating means are arranged in such a way that film path lengths between a position of the second or third coating means and a position of said heat-laminating means are identical.

In addition, a third aspect of the present invention is the manufacturing equipment according to the first aspect of the present invention which further includes a carrier film peeling means for peeling off the second and third carrier films, which are arranged as the outermost layers of a laminated product made by the heat-laminating means; and a winding means for winding on MEAs, which are resultant products after the second and third carrier films are peeled off and removed by the carrier film peeling means.

In addition, a fourth aspect of the present invention is the manufacturing equipment according to the third aspect of the present invention which further includes a first carrier film winding means for winding on and storing the first carrier film after being peeled off by the press-laminating means; a second carrier film winding means for winding on and storing the second carrier film after being peeled off by the carrier film peeling means; and a third carrier film winding means for winding on and storing the third carrier film after being peeled off by the carrier film peeling means.

In addition, a fifth aspect of the present invention is the manufacturing equipment according to the third aspect of the present invention, wherein the carrier film peeling means includes two cooling rolls arranged in such a way that the laminated product made by the heat-laminating means is arranged between the two cooling rolls, and the second carrier film and the third carrier film are simultaneously peeled off along each of the cooling rolls.

In addition, a sixth aspect of the present invention is a manufacturing method of a fuel cell MEA which includes feeding, transferring, and winding a first carrier film in a belt shape; coating an electrolyte material in predetermined regions on the first carrier film; drying the electrolyte material coated on the first carrier film to transform into an electrolyte membrane; feeding, transferring, and winding a second carrier film in a belt shape; intermittently coating an electrode catalyst layer material in predetermined regions on the second carrier film; drying the electrode catalyst layer material coated intermittently on the second carrier film to transform into an electrode catalyst layer; feeding, transferring, and winding a third carrier film in a belt shape; intermittently coating an electrode catalyst layer material in predetermined regions on the third carrier film; drying the electrode catalyst layer material coated intermittently on the third carrier film to transform into an electrode catalyst layer; press laminating the electrolyte membrane formed on the first carrier film onto the electrode catalyst layer on the second carrier film followed by peeling off and removing the first carrier film; and thermally laminating the electrode catalyst layer on the third carrier film onto the electrolyte membrane with a pressure.

In addition, a seventh aspect of the present invention is the manufacturing method according to the sixth aspect of the present invention which further includes peeling off the second and third carrier films, which are arranged as the outermost layers of a laminated product made by thermally laminating; and winding on MEAs, which are resultant products after the second and third carrier films are peeled and removed.

In addition, an eighth aspect of the present invention is the manufacturing method according to the seventh aspect of the present invention, wherein the second and third carrier films, which are arranged as the outermost layers of the laminated product made by the thermally laminating, are peeled off simultaneously.

The manufacturing equipment and the manufacturing method of the present invention make it possible to produce a large number of MEA continuously. In addition, since heats and pressures applied on both sides of the thin electrolyte membrane become the same in the present invention, in which an electrode catalyst layer formed on a carrier film and a thin electrolyte membrane simultaneously receive thermally laminating treatment, the electrolyte membrane is not damaged so that a generation of leakage is prevented.

In addition, the transfer rates of the first to third carrier films are kept identical and the tensions of the first to third carrier films are maintained in an appropriate condition by the tension control means so that electrode catalyst layers and an electrolyte membrane which have even thicknesses are formed.

In addition, since the electrode catalyst layer material is coated in only required regions on the carrier film so that almost all the electrode catalyst layer material used in the coating process is not wasted, a high level of material efficiency is achieved. Moreover, regions which are supposed to be used by a sealing material are not contaminated by the electrode catalyst layer material so that an increase in a defective ratio caused by a leakage can be prevented.

### BRIEF DESCRIPTION OF THE DRAWINGS

FIG. 1 illustrates an exemplary diagram of an embodiment of manufacturing equipment of an MEA of the present invention.

FIG. 2A shows an exemplary side view of a layered product after heat lamination.

FIG. 2B shows an overview exemplary diagram of a layered product E after peeling off the carrier film B and C.

FIG. 3 shows the intermittent coating of an electrode catalyst layer of the present invention.

### DESCRIPTION OF REFERENCE NUMERALS AND SIGNS

1: Film feeding part for carrier film A for the electrolyte.
2: Coating roll on which the electrolyte is coated.
3: Film transfer roll for carrier film A.
4: Film winding part for carrier film A for the electrolyte.
5: Film feeding part for carrier film B for the electrode catalyst layer.
6: Film feeding part for carrier film C for the electrode catalyst layer.
7: Coating roll on which the electrode catalyst layer is coated.
8: Coating roll on which the electrode catalyst layer is coated.
9: Nip roll
11: Thermal laminating roll
12: Thermal laminating roll
13, 14: Cooling roll
15: Film winding part for carrier film B for the electrolyte.
16: Film winding part for carrier film C for the electrolyte.
17: Film winding part for laminated product E.
21: Electrolyte coating means.
22, 23: Electrode catalyst layer coating means.
24: Laminating pressure control means.
25: Nip pressure control means.
26, 27, 28: Drying oven.
41: Electrolyte material. Electrolyte membrane.
42, 43: Electrode catalyst layer material. Electrode catalyst layer.
A: Carrier film for electrolyte.
B, C: Carrier film for electrode catalyst layer.
D: Laminated product after thermal lamination.
E: Laminated product after peeling off the carrier films B and C.
G: Gap between the coating means and the carrier film surface.

### DETAILED DESCRIPTION OF THE INVENTION

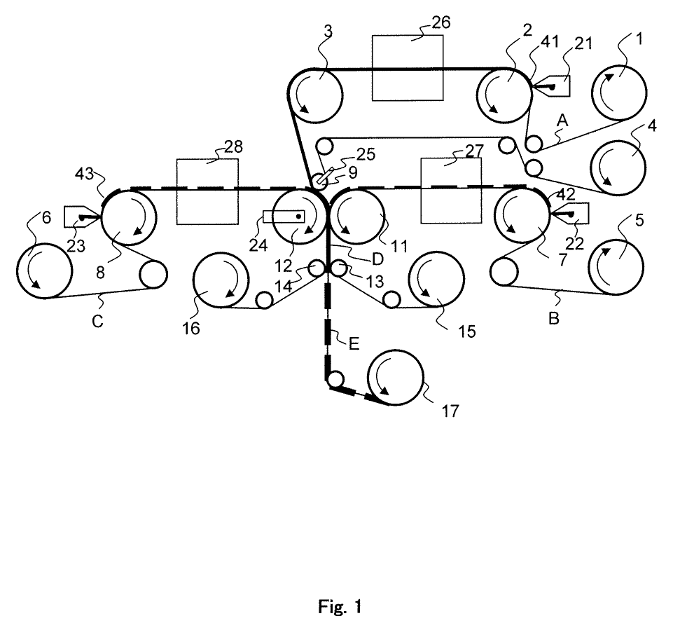

Referring to the figures, embodiments of the present invention will be described below. FIG. 1 illustrates an exemplary diagram of MEA manufacturing equipment of an embodiment of the present invention.

First, a carrier film A is wound off with a constant feed rate and a constant tension from a film feeding part 1. An electrolyte material 41 with a predetermined width and uniform thickness is coated on the carrier film A on a coating roll 2 by a coating means 21.

The carrier film A on which the electrolyte material 41 is coated is transferred into a drying oven 26. Then, the electrolyte material 41 is dried and an electrolyte membrane 41 is formed on the carrier film.

Meanwhile, a carrier film B and C are wound off respectively with a constant feed rate and a constant tension from film feeding parts 5 and 6 which are arranged facing each other, and electrode catalyst materials 42 and 43 are intermittently coated on the carrier films B and C on coating rolls 7 and 8 by coating means 22 and 23, respectively. The electrode catalyst materials 42 and 43 are coated with a constant thickness and a width narrower than that of the electrolyte membrane 41.

The electrode catalyst layer 42 and 43 which are formed on both sides of the electrolyte membrane 41 are aligned with each other by making film paths between the coating means 22 or 23 and a thermal laminating roll identical, as well as coating intermittently with identical timings.

The carrier film B or C, on which the electrode catalyst material 42 or 43 is coated intermittently, is transferred into a drying oven 27 or 28. Then, the electrode catalyst material 42 or 43 is dried to be transformed into an electrode catalyst layer 42 or 43.

Next, the electrolyte membrane 41, which is formed on the carrier film A, is pressed and laminated to the electrode catalyst layer 43, which is formed on the carrier film C, by a nip roll 9 on a thermal laminating roll 12, which transfers the carrier film C having an intermittent coating of the electrode catalyst layer 43,.

The nip roll 9 has a nip pressure control means 25 to control nip pressure so that a gap between the nip roll 9 and the thermal laminating roll 12 is controlled.

Subsequently, transferring along the nip roll 9, the carrier film A is peeled off and separated from the electrolyte membrane 41. The carrier film A which has carried the electrolyte membrane 41 after being peeled off and separated is wound on a winding part 4 to be reused as a carrier film for an electrolyte membrane.

The carrier film B, on which the electrode catalyst layer 42 is coated, is also transferred onto a thermal laminating roll 11. The thermal laminating rolls 11 and 12 are arranged facing each other. The electrode catalyst layer 43 and the electrolyte membrane 41 on the carrier film C and the electrode catalyst layer 42 on the carrier film B are combined, pressed and heated to form a laminated product between the thermal laminating rolls 11 and 12.

At this time, the thermal laminating roll 12, which loads the carrier film C carrying the electrode catalyst layer 43, has a laminating pressure control means 24 to control a pressure during laminating by adjusting a gap width between the two thermal laminating rolls. Any mechanism which keeps the gap between the thermal laminating rolls 12 and 11 parallel and makes the gap width a predetermined value as well as keeps a predetermined laminating pressure can be adopted as the laminating pressure control means 24. Such a mechanism can be realized by using various types of cylinders.

The laminated product D, which has layers in the order of carrier film B, electrode catalyst layer 42, electrolyte membrane 41, electrode catalyst layer 41, and carrier film C, formed by the thermal laminating roll 11 and 12 is cooled by passing between the cooling rolls 13 and 14, which are arranged facing each other.

The carrier films B and C on both outermost layers of the laminated product D are peeled off transferring along the cooling rolls 13 and 14, respectively, to be separated from the laminated product E having the electrode catalyst layer 42, the electrolyte membrane 41 and the electrode catalyst layer 43. Damage that causes a leak defect in the electrolyte membrane 41 can be prevented because peel forces applied on the thin electrolyte membrane 41 becomes identical on both surfaces by peeling off the outermost carrier films B and C simultaneously.

The carrier films B and C after being peeled off are wound on winding parts 15 and 16, respectively, and reused as a carrier film for an electrode catalyst layer.

The laminated product E is wound on a winding part 17 and provided to the following process.

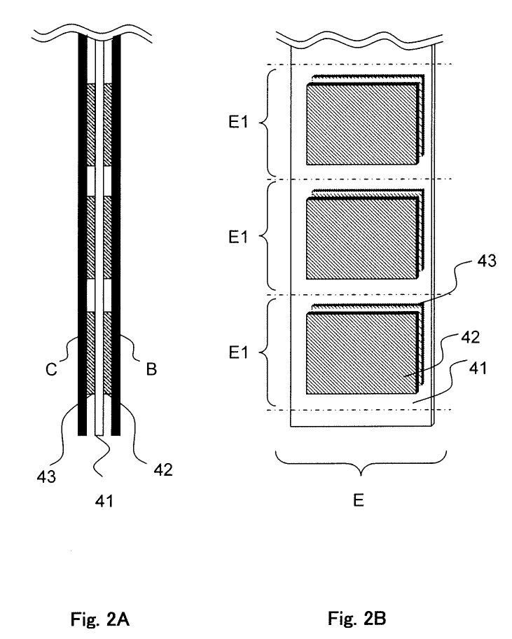

FIG. 2A is an exemplary side view of the laminating product D. The electrode catalyst layer 42 and 43 are laminated intermittently on both surfaces of the electrolyte membrane 41 and the outermost layers are the carrier films B and C. As described above, both the outermost carrier films B and C are peeled off simultaneously when the laminated product D passes between the cooling rolls 13 and 14.

FIG. 2B shows an exemplary diagram of the laminating product E. The electrode catalyst layers 42 and 43 are formed in the same shapes and in similar positions of both surfaces of the electrolyte membrane 41. The electrode catalyst layers 42 and 43 are coated intermittently with a narrower width than the electrolyte membrane 41 so that doted coated patterns of the electrode catalyst layers 42 and 43, around which only the electrolyte membrane 41 is coated, is formed.

A sheet of MEA E1 is obtained by cutting the laminated product E along dashed-dotted lines showed in FIG. 2B, which are never across areas in which the electrode catalyst layers 42 and 43 are formed. The manufacturing equipment of the present invention makes it possible to produce a number of MEAs E1 efficiently by manufacturing the laminated product E continuously. In addition, the electrode catalyst layers 42 and 43 are formed only on predetermined regions of the carrier films B and C, and are transferred to the electrolyte membrane 41 completely so that there is no electrode catalyst layer material wasted and a high level of material efficiency is achieved.

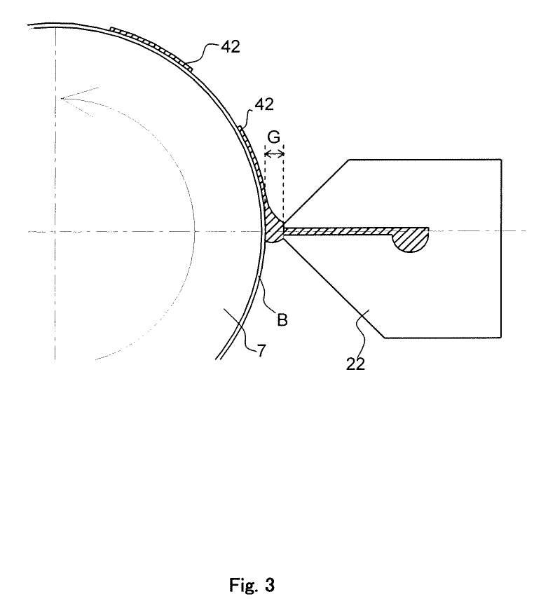

FIG. 3 illustrates a detailed view of coating the electrode catalyst layer 42 intermittently on the carrier film B. A view of coating the electrode catalyst layer 43 intermittently on the carrier film C is also similar to FIG. 3. A width of gap G between the electrode catalyst layer coating means 22 and a surface of the carrier film B is controlled with a high level of precision. It is preferred that the gap G width is controlled with a repeatable precision of ±5 μm so that the electrode catalyst layer is intermittently coated with an even thickness.

Although FIG. 1 and FIG. 3 show a case of using a die head as the electrolyte coating means 21, the electrode catalyst layer coating means 22 and 23, the coating means of the present invention is not limited to a die head. As long as the coating thickness is controllable, any other known coating means can be used.

In other words, for example, screen printing etc. other than die coating may be employed as a method for intermittently coating an electrode catalyst layer material on a carrier film.

A manufacturing method of MEA of the present invention is described below. In this invention the MEA is fabricated in such a way that a pair of the electrode catalyst layers faces both surfaces of the electrolyte membrane, respectively.

Any proton conductive electrolyte materials such as fluoropolymer electrolyte and hydrocarbon polymer electrolyte can be used as the electrolyte membrane which is used in a manufacturing method of MEA of the present invention. For example, Nafion (a registered trademark) by DuPont, Flemion (a registered trademark) by Asahi Glass Co., Ltd., Aciplex (a registered trademark) by Asahi Kasei Corp., and Gore Select (a registered trademark) by W. L. Gore & Associate, Inc., etc. can be used as the fluoropolymer electrolyte while electrolyte materials such as sulfonated poly(ether ketone), sulfonated poly(ether sulfone), sulfonated poly(ether ether sulfone), sulfonated polysulfide and sulfonated polyphenylene etc. can be used as the hydrocarbon polymer electrolyte. Among these, Nafion series materials by DuPont are preferably used.

A solvent is added to the electrolyte material. For example, alcohols such as methanol, ethanol, 1-propanol, 2-propanol, 1-butanol, 2-butanol, isobutyl alcohol, tert-butyl alcohol, pentanol, 2-heptanol and benzyl alcohol etc., ketones such as acetone, methyl ethyl ketone, methyl propyl ketone, methyl butyl ketone, methyl isobutyl ketone, methyl amyl ketone, pentanone, heptanone, cyclohexanone, methylcyclohexanone, acetonyl acetone, diethyl ketone, dipropyl ketone and dilsobutyl ketone etc., ethers such as tetrahydrofuran, tetrahydropyran, dioxane, diethylene glycol dimethyl ether, anisole, methoxytoluene, diethyl ether, dipropyl ether and dibutyl ether etc., amines such as isopropylamine, butylamine, isobutylamine, cyclohexylamine, diethylamine and aniline etc., esters such as propyl formate, isobutyl formate, amyl formate, methyl acetate, ethyl acetate, propyl acetate, butyl acetate, isobutyl acetate, pentyl acetate, isopentyl acetate, methyl propionate, ethyl propionate and butyl propionate etc., as well as acetic acid, propionic acid, dimethylformamide, dimethylacetoamide, N-methylpyrrolidone, ethylene glycol, diethylene glycol, propylene glycol, ethylene glycol monomethyl ether, ethylene glycol dimethyl ether, ethylene glycol diethyl ether, diacetone alcohol and/or 1-methoxy-2-propanol etc. are used as the solvent. Water may also be used as the solvent. In addition, a mixed solvent of these can also be used.

An electrode catalyst layer material of an electrode catalyst layer which is used in a manufacturing method of MEA of the present invention contains at least catalyst loading particles and an electrolyte material.

For example, metals of platinum group elements such as platinum, palladium, ruthenium, iridium, rhodium and osmium, other metals such as iron, lead, copper, chromium, cobalt, nickel, manganese, vanadium, molybdenum, gallium and aluminum etc., oxides of these metals, and multiple oxides of these metals can be used as the catalyst in the present invention. In addition, the size (particle diameter) of the catalyst is preferred to be in the range of 0.5-20 nm because larger particles have insufficient catalytic activities and smaller particles are not stable. Catalyst particles with a size in the 1-5 nm range are more preferable.

Carbon particles can be used as the particles for the catalyst loading particles. Any type of carbon such as carbon black, graphite, active carbon, carbon fiber, carbon nanotube and fullerene are available as the particles as long as they are chemically inactive against the catalyst. A particle diameter of the carbon particles is preferred to be in the range of 10-1000 nm because smaller particles have difficulty in forming a conductive path while larger particles prevent sufficient gas diffusion in the electrode catalyst layer and a catalytic efficiency decreases. Carbon particles with a size in the range of 10-100 nm are more preferable. Any proton conductive electrolytes including similar materials to those for the electrolyte membrane can be used as the electrolyte material of the electrode catalyst layer material. Fluoropolymer electrolytes and hydrocarbon polymer electrolytes can be used. For example, Nafion (a registered trademark) by DuPont etc. can be used as the fluoropolymer electrolytes while electrolyte materials such as sulfonated poly(ether ketone), sulfonated poly(ether sulfone), sulfonated poly(ether ether sulfone), sulfonated polysulfide and sulfonated polyphenylene etc. can be used as the hydrocarbon polymer electrolytes. Considering adhesiveness between the electrode catalyst layer and the electrolyte membrane, it is preferable that the same electrolyte materials are used in the electrode catalyst layer material and in the electrolyte membrane.

A solvent is added to the electrode catalyst layer material. For example, alcohols such as methanol, ethanol, 1-propanol, 2-propanol, 1-butanol, 2-butanol, isobutyl alcohol, tert-butyl alcohol, pentanol, 2-heptanol and benzyl alcohol etc., ketones such as acetone, methyl ethyl ketone, methyl propyl ketone, methyl butyl ketone, methyl isobutyl ketone, methyl amyl ketone, pentanone, heptanone, cyclohexanone, methylcyclohexanone, acetonyl acetone, diethyl ketone, dipropyl ketone and diisobutyl ketone etc., ethers such as tetrahydrofuran, tetrahydropyran, dioxane, diethylene glycol dimethyl ether, anisole, methoxytoluene, diethyl ether, dipropyl ether and dibutyl ether etc., amines such as isopropylamine, butylamine, isobutylamine, cyclohexylamine, diethylamine and aniline etc., esters such as propyl formate, isobutyl formate, amyl formate, methyl acetate, ethyl acetate, propyl acetate, butyl acetate, isobutyl acetate, pentyl acetate, isopentyl acetate, methyl propionate, ethyl propionate and butyl propionate etc., as well as acetic acid, propionic acid, dimethylformamide, dimethylacetoamide, N-methylpyrrolidone, ethylene glycol, diethylene glycol, propylene glycol, ethylene glycol monomethyl ether, ethylene glycol dimethyl ether, ethylene glycol diethyl ether, diacetone alcohol and/or 1-methoxy-2-propanol etc. are used as the solvent. Water may also be used as the solvent. In addition, a mixed solvent of these can also be used.

A manufacturing method and manufacturing equipment of MEA of the present invention was described above. The present invention, however, is not limited only to the case which is described above but can be applied to other cases (manufacturing methods and manufacturing equipment) where laminated products similar to the MEA described above are manufactured.

What is claimed is:

1. Manufacturing equipment of a fuel cell MEA comprising:
a first transfer means for feeding, transferring, and winding a first carrier film in a belt shape;
a first coating means for coating an electrolyte material in predetermined regions on said first carrier film;
a first drying means for drying said electrolyte material coated on said first carrier film to transform into an electrolyte membrane;
a second transfer means for feeding, transferring, and winding a second carrier film in a belt shape;
a second coating means for intermittently coating an electrode catalyst layer material in predetermined regions on said second carrier film;
a second drying means for drying said electrode catalyst layer material coated intermittently on said second carrier film to transform into an electrode catalyst layer;
a third transfer means for feeding, transferring, and winding a third carrier film in a belt shape;
a third coating means for intermittently coating an electrode catalyst layer material in predetermined regions on said third carrier film;
a third drying means for drying said electrode catalyst layer material coated intermittently on said third carrier film to transform into an electrode catalyst layer;
a press-laminating means for laminating said electrolyte membrane formed on said first carrier film onto said electrode catalyst layer on said second carrier film with a pressure followed by peeling off and removing said first carrier film; and
a heat-laminating means for laminating said electrode catalyst layer on said third carrier film onto said electrolyte membrane with heat and a pressure.

2. The manufacturing equipment according to claim 1, further comprising:
a synchronizing means for synchronizing intermittently coatings on said second carrier film and on said third carrier film when said electrode catalyst materials are intermittently coated; and
a tension control means for controlling a transfer rate and a tension of said first to third carrier films, wherein said second and said third coating means are arranged in such a way that film path lengths between a position of said second or said third coating means and a position of said heat-laminating means are identical.

3. The manufacturing equipment according to claim 1, further comprising:
a carrier film peeling means for peeling off said second and said third carrier films, which are arranged as the outermost layers of a laminated product made by said heat-laminating means; and
a winding means for winding on MEAs, which are resultant products after said second and said third carrier films are peeled off and removed by said carrier film peeling means.

4. The manufacturing equipment according to claim 3, further comprising:
a first carrier film winding means for winding on and storing said first carrier film after being peeled off by said press-laminating means;
a second carrier film winding means for winding on and storing said second carrier film after being peeled off by said carrier film peeling means; and
a third carrier film winding means for winding on and storing said third carrier film after being peeled off by said carrier film peeling means.

5. The manufacturing equipment according to claim 3, wherein said carrier film peeling means includes two cooling rolls arranged in such a way that said laminated product made by said heat-laminating means is arranged between said two cooling rolls, and said second carrier film and said third carrier film are simultaneously peeled off along each of said cooling rolls.

6. A manufacturing method of a fuel cell MEA comprising:
feeding, transferring, and winding a first carrier film in a belt shape;
coating an electrolyte material in predetermined regions on said first carrier film;
drying said electrolyte material coated on said first carrier film to transform into an electrolyte membrane;
feeding, transferring, and winding a second carrier film in a belt shape;
intermittently coating an electrode catalyst layer material in predetermined regions on said second carrier film;
drying said electrode catalyst layer material coated intermittently on said second carrier film to transform into an electrode catalyst layer;
feeding, transferring, and winding a third carrier film in a belt shape;
intermittently coating an electrode catalyst layer material in predetermined regions on said third carrier film;
drying said electrode catalyst layer material coated intermittently on said third carrier film to transform into an electrode catalyst layer;
press laminating said electrolyte membrane formed on said first carrier film onto said electrode catalyst layer on said second carrier film followed by peeling off and removing said first carrier film; and
thermally laminating said electrode catalyst layer on said third carrier film onto said electrolyte membrane with a pressure.

7. The manufacturing method according to claim 6, further comprising:
peeling off said second and said third carrier films, which are arranged as the outermost layers of a laminated product made by thermally laminating; and
winding on MEAs, which are resultant products after said second and said third carrier films are peeled off and removed.

8. The manufacturing method according to claim 7, wherein said second and said third carrier films, which are arranged as said outermost layers of said laminated product made by said thermally laminating, are peeled off simultaneously.
